(19) United States
(12) Patent Application Publication
(10) Pub. No.: US 2024/0327282 A1
(43) Pub. Date: Oct. 3, 2024

(54) METHOD OF PREPARING ALKALI-ACTIVATED CEMENT BY STEPWISE CALCINATION WITH SODIUM CHLORIDE

(71) Applicants: HUNAN UNIVERSITY OF SCIENCE AND TECHNOLOGY, Xiangtan (CN); HUNAN XIANGCHU XIANLU ENVIRONMENTAL PROTECTION TECHNOLOGY CO., LTD., Changsha (CN)

(72) Inventors: Meixun PENG, Xiangtan (CN); Qiming ZHAO, Xiangtan (CN); Yuanpeng ZHANG, Xiangtan (CN); Wenwei LIU, Changsha (CN); Meilin CHEN, Changsha (CN)

(21) Appl. No.: 18/737,912

(22) Filed: Jun. 7, 2024

(30) Foreign Application Priority Data
Feb. 24, 2024 (CN) 202410204515.7

(51) Int. Cl. C04B 7/42; C04B 7/24; C04B 7/43; C04B 7/47; C04B 7/52; C04B 103/10; C04B 111/00

(52) U.S. Cl. CPC C04B 7/424; C04B 7/243; C04B 7/434; C04B 7/47; C04B 7/52; C04B 2103/10; C04B 2111/00017

(57) ABSTRACT

A method of preparing alkali-activated cement by stepwise calcination with sodium chloride includes the following steps. (1) Sodium chloride, a silicate and a carbonate are mixed and finely ground to obtain a raw material powder. (2) The raw material powder is calcined sequentially at 850-1050° C. and 1240° C. or more, and cooled to obtain a clinker. (3) The clinker is mixed with at least one of sodium hydroxide and potassium hydroxide, and ground finely to produce a cement powder.

### CROSS-REFERENCE TO RELATED APPLICATIONS

This application claims the benefit of priority from Chinese Patent Application No. 202410204515.7, filed on Feb. 24, 2024. The content of the aforementioned application, including any intervening amendments thereto, is incorporated herein by reference in its entirety.

### TECHNICAL FIELD

This application relates to cement building materials, and more particularly to a method of preparing alkali-activated cement by stepwise calcination with sodium chloride.

### BACKGROUND

The preparation of silicate cement clinker has some problems such as high carbon emissions, high energy and material consumptions, serious dust pollutions, serious sulfur and nitrogen oxide gas pollutions, and poor corrosion resistance and durability. Alkali-activated cement has the outstanding advantages of high early strength, and excellent corrosion resistance and freeze-thaw resistance. Moreover, the alkali-activated cement has an energy-saving and environmentally-friendly preparation process due to the full use of solid waste slags, and is thus widely accepted as an alternative to the silicate cement. Traditional alkali-activated cement is a bi-component cement hardened by activating amorphous aluminosilicate (calcium) salts with strong alkalis, and still has some shortcomings. (1) Kaolin resources are scarce, and the price of other raw materials, such as fly ash and blast furnace slag, is continuously rising since they have been extensively consumed as the admixtures of silicate cement. (2) The large consumption of industrial alkali activators (3-14 wt % calculated by the dosage of Na₂O) also brings high cost, and will make the concrete prone to efflorescence, thereby affecting the durability. (3) Considering the inherent composition variability, it is difficult to stably regulate and standardize the performance and preparation of the alkali-activated cement with the industrial wastes as main raw materials.

Reducing and eliminating the consumption of the alkali activator can effectively reduce the cost of alkali-activated cement. Chinese patent publication Nos. 110371140A and 110451827A disclosed preparation and use of an alkali-activated cement curing at room-temperature and promoted temperature, respectively. Specifically, a small amount of industrial alkali, sodium potassium aluminosilicates, and calcium-containing raw materials are mixed, ground and calcined at 1250-1300° C. before quickly cooling to obtain the clinker, which is then finely ground, and uniformly mixed with the sodium silicate water glass to produce the cement. The 28-day compressive strengths of the resultant cement pastes exceed 80 MPa and 110 MPa, respectively. Moreover, the dosage of the alkali activator is reduced compared to the common bi-component alkali-activated cement. However, the industrial alkali and the sodium potassium aluminosilicate used in the clinker calcination are not cheap, which still lead to an increase in the cost of alkali-activated cements.

### SUMMARY

In view of the deficiencies in the prior art, this application provides a method of preparing alkali-activated cement by stepwise calcination with sodium chloride, which employs cheap raw materials for the clinker calcination, and can reduce the dosage of the alkali activator, allowing for a significantly reduced preparation cost.

Technical solutions of this application are described as follows.

This application provides a method of preparing an alkali-activated cement by stepwise calcination with sodium chloride, comprising:
(1) mixing a sodium chloride, a silicate and a carbonate followed by grinding to obtain a raw material powder;
(2) sequentially subjecting the raw material powder to a first calcination at 850-1050° C., a second calcination at 1240° C. or more and rapid cooling to obtain a clinker; and
(3) mixing the clinker with an alkali to produce the alkali-activated cement, wherein the alkali is sodium hydroxide, potassium hydroxide or a combination thereof;

wherein a mixture of the silicate and the carbonate is adapted to produce a residue comprising SiO₂, Al₂O₃, CaO, and MgO after oxidative calcination at 950±25° C. according to the method in GB/T 176-2017; a total weight of SiO₂, Al₂O₃, CaO, and MgO accounts for 90.0% or more by weight of the residue; SiO₂ accounts for 31.0-47.0% by weight of the residue; Al₂O₃ accounts for 12.4-18.0% by weight of the residue; CaO accounts for 21.3-46.3% by weight of the residue; and MgO accounts for 0-16.2% by weight of the residue;

in the step (1), the sodium chloride is 8.0-20.0% by weight of the residue; and

in the step (3), a weight of the alkali is calculated as follows:

(a weight of NaOH+0.713×a weight of KOH)/a weight of the clinker=(0.5-3.0)%.

In an embodiment, in the step (1), the grinding is performed such that the raw material powder is capable of passing through a 80 μm square-hole sieve.

In an embodiment, in the step (2), the first calcination is performed for at least 1 hour.

In an embodiment, in the step (2), water vapor is injected at a flow rate of 80 g·min⁻¹·m⁻² or more during the first calcination.

In an embodiment, in the step (2), the second calcination is performed for at least 1 hour.

In an embodiment, in the step (2), the rapid cooling is performed by water quenching or air blast cooling.

In an embodiment, the step (3) is performed through steps of: grinding the clinker to obtain a clinker powder; dissolving the alkali in water to obtain an alkali solution; and mixing the clinker powder with the alkali solution to produce the alkali-activated cement for use.

In an embodiment, the step (3) further comprises: grinding a mixture of the alkali and the clinker.

In an embodiment, in the step (2), a tail gas produced from the first calcination and the second calcination is collected and dissolved in water to obtain a tail gas-containing aqueous solution; and the tail gas-containing aqueous solution is processed to produce hydrochloric acid or recycle valuable metals.

In an embodiment, in the step (2), a tail gas produced from the first calcination and the second calcination is collected and dissolved in water to obtain a tail gas-containing aqueous solution; and the tail gas-containing aqueous solution is processed to produce hydrochloric acid or recycle valuable metals.

Compared with the prior art, this application has the following beneficial effects.
(1) The preparation process of cement clinker does not need expensive industrial alkali as raw material, and the alkali used for activation is further reduced, so that the preparation cost of alkali-activated cement is reduced to the minimum.
(2) The general cement prepared by the method herein is mainly made of aluminosilicate, which not only significantly reduces carbon emissions compared with silicate cement, but also consumes a large amount of aluminosilicate solid wastes.
(3) Valuable metals in solid waste are recovered simultaneously during the cement preparation process, which improves the resource recovery rate and realizes the full use of solid wastes.
(4) Heavy metals in solid wastes can be removed by chlorination roasting process, and the residual heavy metals can be solidified in cement, which can eliminate the risk of heavy metal pollution while realizing the full utilization of heavy metal-containing solid wastes.
(5) The tail gas discharged in the process of cement preparation can be used to by-produce HCl gas and hydrochloric acid.

### DETAILED DESCRIPTION OF EMBODIMENTS

The present disclosure will be further described in detail below in conjunction with embodiments. It should be understood that the embodiments described herein are only used to illustrate and explain this disclosure, and are not intended to limit the disclosure. The steps including raw material powder preparation, calcination, cement preparation and curing, and tail gas treatment are respectively described below.

### 1. Raw Material Powder Preparation

Silicates used in the disclosure, with SiO₂ and Al₂O₃ as main ingredients, include granite, kaolin, quartz sandstone and lithium tailings. Carbonates include limestone and dolomite. Lead-zinc tailings are a mixture of silicates and carbonates. The lead-zinc tailings contain small amounts of lead and zinc sulfides. The calcium-magnesium aluminosilicate mixtures in all embodiments were obtained from the above silicates and carbonates by quantitative mixing (see Table 1). The composition of the calcium-magnesium aluminosilicate mixture should satisfy the following conditions: a total weight of SiO₂, Al₂O₃, CaO and MgO was not less than 90.0% of a weight of a residue generated after oxidative calcination at 950° C., and weight proportions of individual oxides in the residue were listed as follows: SiO₂:31.0-47.0%, Al₂O₃: 12.4-18.0%, CaO: 21.3-46.3%, and MgO: 0-16.2%. Sodium chloride was added in an amount of 8.0-20.0% of the ignition residue. The sodium chloride was blended with the calcium-magnesium aluminosilicate mixture to obtain the raw material. The raw material was ground to a fineness that all passed through an 80 μm square hole sieve to obtain raw material powder S1.

TABLE 1
Composition of silicate and carbonate raw materials in the
raw material powder of individual embodiments (unit: %)

| | | | Lithium | Quartz | | | Lead-zinc |
|---|---|---|---|---|---|---|---|
| No. | Granite | Kaolin | tailing | sandstone | Limestone | Dolomite | tailings |
| 1 | 41 | 3 | | | 16 | 40 | |
| 2 | | | | | | | 100 |
| 3 | 38 | 10 | | | 12 | 40 | |
| 4 | 30 | 15 | | | | 55 | |
| 5 | | 16 | 34 | | 10 | 40 | |
| 6 | 30 | 12 | | 10 | | 48 | |
| 7 | 33 | 9 | | | 58 | | |
| 8 | 41 | 9 | | | 50 | | |
| 9 | 36 | 9 | | | 50 | 5 | |
| 10 | 27 | 14 | | | 28 | 31 | |
| 11 | 55 | | 55 | | 20 | 25 | |
| 12 | | 30 | | 20 | 25 | 25 | |

### 2. Calcination of Raw Material

The raw material powder S1 was loaded into a boat-shaped corundum crucible and placed into a corundum vacuum tube of a silicon carbide tube-type atmosphere furnace. An outlet end of the atmosphere furnace was equipped with an acid-resistant quartz flange, and an inlet end of the atmosphere furnace was connected to air or water vapor atmosphere as required. A vent pipe at the outlet end was vented into water. The tube-type atmosphere furnace was heated up to 500° C. at a rate of 5° C./min, and then the atmosphere was connected. Air atmosphere was only required to keep a unidirectional movement of the gas in the tube. The water vapor was injected at a flow rate of 80 g·min⁻¹·m⁻² or more. When the working temperature raised to 850-1050° C. to maintain a first constant temperature for 1.0-4.0 hours. After the end of the first constant temperature, the temperature was continued to raise to 1240° C. or higher at the rate of 5° C./min and keep the second temperature constant for 1-3 hours. After finishing calcination, the water vapor injection was stopped, the quartz flange at the outlet end was quickly removed, the hot crucible was removed from the vacuum tube, and the clinker S2 in the crucible was subjected to air blast cooling or water quenching cooling. The main chemical composition and calcination parameters of ignition residue of the calcium-magnesium aluminosilicate mixture, and sodium chloride addition of each embodiment were shown in detail in Table 2.

TABLE 2
Main chemical compositions of residue of calcium-magnesium aluminosilicate mixture,
calcination parameters, and sodium chloride addition in raw materials

| | | | | | | Calcination parameters | | | | | |
|---|---|---|---|---|---|---|---|---|---|---|---|
| | | | | | | | | Vapor | | | |
| | | | | | | | | flow | | | |
| | Chemical | | | | NaCl/ | First | | rate | Last | | |
| | composition | | | | Ignition | section | Holding | (g · | section | Holding | |
| | (%) | | | | residue | temperature | time | min⁻¹ · | temperature | time | Cooling |
| No. | SiO₂ | Al₂O₃ | CaO | MgO | (%) | (° C.) | (h) | m⁻²) | (° C.) | (h) | method |
| 1 | 38.8 | 13.6 | 31.3 | 11.6 | 14 | 1050 | 1 | 0 | 1300 | 2 | Water |
| | | | | | | | | | | | cooling |
| 2 | 46.9 | 12.4 | 25.5 | 11.2 | 17 | 1000 | 1.5 | 0 | 1300 | 1 | Air |
| | | | | | | | | | | | cooling |
| 3 | 39.8 | 16.3 | 27.8 | 11.5 | 20 | 1000 | 2 | 0 | 1300 | 1 | Air |
| | | | | | | | | | | | cooling |
| 4 | 36.9 | 17.2 | 25.7 | 16.2 | 20 | 1000 | 3 | 0 | 1300 | 1 | Water |
| | | | | | | | | | | | cooling |
| 5 | 39.8 | 18.3 | 26.1 | 11.5 | 20 | 1000 | 2.5 | 80 | 1300 | 2 | Water |
| | | | | | | | | | | | cooling |
| 6 | 46.8 | 14.4 | 21.3 | 13.4 | 8 | 850 | 4 | 0 | 1300 | 1 | Water |
| | | | | | | | | | | | cooling |
| 7 | 35.0 | 14.4 | 46.3 | 0.2 | 8 | 950 | 2 | 0 | 1300 | 1 | Water |
| | | | | | | | | | | | cooling |
| 8 | 40.5 | 16.0 | 38.5 | 0.3 | 8 | 1050 | 1 | 0 | 1300 | 3 | Air |
| | | | | | | | | | | | cooling |
| 9 | 37.2 | 15.1 | 41.7 | 1.7 | 14 | 850 | 3 | 0 | 1250 | 2 | Air |
| | | | | | | | | | | | cooling |
| 10 | 33.7 | 15.9 | 37.6 | 9.3 | 16 | 1050 | 2 | 0 | 1250 | 1 | Air |
| | | | | | | | | | | | cooling |
| 11 | 46.1 | 14.9 | 26.1 | 6.9 | 8 | 1000 | 2 | 100 | 1240 | 2 | Water |
| | | | | | | | | | | | cooling |
| 12 | 41.1 | 14.4 | 27.6 | 7.0 | 10 | 1000 | 2 | 200 | 1250 | 3 | Water |
| | | | | | | | | | | | cooling |

### 3. Cement Preparation and Maintenance

The clinker S2 was ground finely into a powder that had cement fineness. The alkali was dissolved with as little water as possible and cooled to room temperature. The alkali was sodium hydroxide (NaOH), potassium hydroxide (KOH) or a combination thereof. The weight of the alkali was calculated by the following formula: (a weight of NaOH+0.713×a weight of KOH)/(a weight of the clinker S2)=(0.5-3.0)%. The alkali solution was mixed with the clinker powder and stirred for 2-5 minutes. During stirring, water was quantitatively mixed for reducing the consistency of the paste, so as to facilitate liquefying the paste during subsequent vibration. The paste was moved into the 40×40×40 steel mold for vibrocompaction. Then, the paste together with the steel mold was transferred into a cement standard maintenance box at 20° C. and a humidity of no less than 90% for 1 day followed by demolding. When the strength after one-day maintenance did not meet the requirements of demolding, the demolding step was delayed, and then continued to perform the standard curing in humidity for 3 days, 7 days and 28 days. The compressive strength of the samples at different phases was tested, respectively. The composition addition amount and compressive strength of cement paste were shown in Table 3. As shown in table 3, as the addition amount of alkali increased, the strength of cement showed an increasing trend, and the maximum value of 28-day compressive strength of cement paste reached 82.5 MPa.

TABLE 3
Chlorine content of cement clinker, addition amount
and compressive strength of cement paste

| | Chlorine | | | Liquid- | | | |
|---|---|---|---|---|---|---|---|
| | content (%) | Activator/clinker (%) | | solid | Compressive strength (MPa) | | |
| No. | in clinker | KOH | NaOH | ratio | 3 day | 7 day | 28 day |
| 1 | 0.95 | | 1.0 | 0.26 | 13.0 | 20.1 | 31.8 |
| 2 | 0.45 | 1.0 | | 0.26 | 11.7 | 14.0 | 20.8 |
| 3 | 0.82 | | 0.5 | 0.25 | 9.1 | 15.6 | 21.5 |
| 4 | 0.65 | 1.0 | 1.0 | 0.26 | 14.5 | 16.7 | 37.0 |
| 5 | 0.15 | 1.0 | 2.0 | 0.27 | 36.6 | 50.7 | 73.3 |
| 6 | 0.56 | | 1.0 | 0.26 | 14.1 | 19.1 | 25.5 |
| 7 | 0.73 | 0.7 | | 0.26 | 10.3 | 17.0 | 27.3 |
| 8 | 0.12 | | 3.0 | 0.26 | 38.8 | 63.6 | 82.5 |
| 9 | 1.35 | | 1.0 | 0.26 | 14.9 | 19.5 | 29.4 |
| 10 | 1.24 | | 1.0 | 0.26 | 8.7 | 10.8 | 26.8 |
| 11 | 0.18 | | 2.0 | 0.27 | 12.7 | 16.8 | 33.4 |
| 12 | 0.08 | 4.0 | | 0.28 | 25.5 | 41.1 | 59.8 |

### 4. Treatment of Tail Gas-Containing Aqueous Solution

The chemical composition of the cooled clinker S2 was tested. The residual chlorine ion in the calcination residue ranged from 0.08% to 1.35% (see Table 3). Most of the results were close to the chlorine content (0.10%) required for general silicate cements. By increasing the holding time in the last section, the chlorine content could be expected to reduce to the cement standard requirement (see Example 12). X-ray fluorescence spectroscopy found that the Pb and Zn contents in Example 2 were much lower than that of the Pb—Zn tailings, removing rate of Pb was 90.5%, and removing rate of Zn was 66.4%. The removed Pb and Zn metals in these examples were dissolved in the tail gas-dissolved water and can be recovered by physic-chemical treatment. Other examples that did not contain valuable metals and heavy metals, the tail gas-containing aqueous can be distilled to obtain purified HCl gas, which can be dissolved in water to obtain hydrochloric acid.

What is claimed is:

1. A method of preparing an alkali-activated cement by stepwise calcination with sodium chloride, comprising:
(1) mixing a sodium chloride, a silicate and a carbonate followed by grinding to obtain a raw material powder;
(2) sequentially subjecting the raw material powder to a first calcination at 850-1050° C., a second calcination at 1240° C. or more and cooling to obtain a clinker; and
(3) mixing the clinker with an alkali to produce the alkali-activated cement, wherein the alkali is sodium hydroxide, potassium hydroxide or a combination thereof;
wherein a mixture of the silicate and the carbonate is adapted to produce a residue comprising SiO₂, Al₂O₃, CaO, and MgO after oxidative calcination at 950±25° C.; a total weight of SiO₂, Al₂O₃, CaO, and MgO accounts for 90.0% or more by weight of the residue; SiO₂ accounts for 31.0-47.0% by weight of the residue; Al₂O₃ accounts for 12.4-18.0% by weight of the residue; CaO accounts for 21.3-46.3% by weight of the residue; and MgO accounts for 0-16.2% by weight of the residue;
in the step (1), the sodium chloride is 8.0-20.0% by weight of the residue; and
in the step (3), a weight of the alkali is calculated as follows:
(a weight of NaOH+0.713×a weight of KOH)/a weight of the clinker=(0.5-3.0)%.

2. The method of claim 1, wherein in the step (1), the grinding is performed such that the raw material powder is capable of passing through an 80 μm square-hole sieve.

3. The method of claim 1, wherein in the step (2), the first calcination is performed for at least 1 hour.

4. The method of claim 1, wherein in the step (2), water vapor is injected at a flow rate of 80 g·min⁻¹·m⁻² or more during the first calcination.

5. The method of claim 1, wherein in the step (2), the second calcination is performed for at least 1 hour.

6. The method of claim 1, wherein in the step (2), the cooling is performed by water quenching or air blast cooling.

7. The method of claim 1, wherein the step (3) is performed through steps of:
grinding the clinker to obtain a clinker powder;
dissolving the alkali in water to obtain an alkali solution; and
mixing the clinker powder with the alkali solution to produce the alkali-activated cement for use.

8. The method of claim 1, wherein the step (3) further comprises:
grinding a mixture of the alkali and the clinker.

9. The method of claim 1, wherein in the step (2), a tail gas produced from the first calcination and the second calcination is collected and dissolved in water to obtain a tail gas-containing aqueous solution; and the tail gas-containing aqueous solution is processed to produce hydrochloric acid or recycle valuable metals.

10. The method of claim 4, wherein in the step (2), a tail gas produced from the first calcination and the second calcination is collected and dissolved in water to obtain a tail gas-containing aqueous solution; and the tail gas-containing aqueous solution is processed to produce hydrochloric acid or recycle valuable metals.
